(19) United States
(12) Patent Application Publication
(10) Pub. No.: US 2013/0011634 A1
(43) Pub. Date: Jan. 10, 2013

(54) PRESSURE-SENSITIVE ADHESIVE SHEET AND LAMINATE

(75) Inventors: Michirou Kawanishi, Ibaraki-shi (JP); Tadatoshi Nakanishi, Ibaraki-shi (JP)

(73) Assignee: NITTO DENKO CORPORATION, Ibaraki-shi (JP)

(21) Appl. No.: 13/540,946

(22) Filed: Jul. 3, 2012

(30) Foreign Application Priority Data
Jul. 8, 2011 (JP) 2011-151345

(51) Int. Cl. B32B 3/10; B32B 7/12

(52) U.S. Cl. 428/195.1; 428/343; 428/411.1

(57) ABSTRACT

The invention provides a pressure-sensitive adhesive sheet which is to be attached to a member having a connecting terminal (e.g., FPC connector) in an end area thereof and allows the connecting terminal to be easily used without shape processing of the sheet. The pressure-sensitive adhesive sheet is to be attached to a region of a member having a connecting terminal in an end area thereof, which region includes the connecting terminal. The pressure-sensitive adhesive sheet includes an adhesive face to be attached to the region including the connecting terminal, and the adhesive face having a non-adhesive region as a region corresponding to the connecting terminal.

### TECHNICAL FIELD

The present invention relates to a pressure-sensitive adhesive sheet to be attached to a region of a member having a connecting terminal in an end area thereof, which includes the connecting terminal. The present invention also relates to a laminate of the pressure-sensitive adhesive sheet with such a member having a connecting terminal in an end area thereof.

### BACKGROUND ART

Various areas have recently widely employed liquid crystal displays (LCDs) and other display devices, as well as touch panels and other input devices to be used in combination with the display devices. Typically in production of such display devices and input devices, pressure-sensitive adhesive sheets (pressure-sensitive adhesive tapes) are used for affixing optical members (see, for example, Patent Literature (PTL) 1).

Typically, with reference to FIG. 7, a touch panel includes an optical member 3 (e.g., deflector plate) and a transparent electrode substrate 2 laminated on each other through the medium of a pressure-sensitive adhesive sheet 101. The transparent electrode substrate 2 includes a glass or film substrate, and electrodes arranged thereon.

The transparent electrode substrate 2 herein generally has connectors 4 in an end area of the glass or film substrate as illustrated in FIG. 4. Each connector 4 includes a flexible circuit (flexible printed circuit; FPC) board, to which leads from the respective electrodes are assembled. When the pressure-sensitive adhesive sheet 101 is used for bonding the optical member 3 and the transparent electrode substrate 2 to each other, notches 105 are generally formed in the pressure-sensitive adhesive sheet 101, as illustrated in FIG. 8. The notches 105 are formed so as to avoid the contact of the connectors 4 with the pressure-sensitive adhesive sheet 101 to thereby allow the connectors 4 to be used even after the attachment of the pressure-sensitive adhesive sheet 101.

### CITATION LIST

### Patent Literature

PTL 1: Japanese Unexamined Patent Application Publication (JP-A) No. 2003-238915

### SUMMARY OF INVENTION

### Technical Problem

The aforementioned configuration requires processing of the shape of the pressure-sensitive adhesive sheet according to the positions of the connectors 4 in the transparent electrode substrate 2 as illustrated in FIG. 8. Such processing step, however, is desirably avoided from the viewpoint of improved productivity of the pressure-sensitive adhesive sheet.

In addition, electronic appliances bearing touch panels have become thinner and thinner recently, and pressure-sensitive adhesive sheets for use in the touch panels should be thinner. However, such a smaller thickness of a pressure-sensitive adhesive sheet makes the processing of the pressure-sensitive adhesive sheet difficult, thus further lowering the productivity of the pressure-sensitive adhesive sheet.

Accordingly, an object of the present invention is to provide a pressure-sensitive adhesive sheet which is to be attached to a member having a connecting terminal (such as an FPC connector) in an end area thereof and which allows the connecting terminal to be used easily without shape processing of the sheet.

### Solution to Problem

The present invention provides, in an aspect, a pressure-sensitive adhesive sheet to be attached to a region of a member having a connecting terminal in an end area thereof, the region including the connecting terminal. The pressure-sensitive adhesive sheet includes an adhesive face to be attached to the region including the connecting terminal, and the adhesive face has a non-adhesive region as a region corresponding to the connecting terminal.

In the pressure-sensitive adhesive sheet according to the present invention, the adhesive face preferably has a size approximately the same with that of a surface of the member, which surface includes the region including the connecting terminal.

In the pressure-sensitive adhesive sheet according to the present invention, the non-adhesive region is preferably a region of a print layer present on the adhesive face.

The pressure-sensitive adhesive sheet according to the present invention is preferably a double-coated pressure-sensitive adhesive sheet.

The pressure-sensitive adhesive sheet according to the present invention preferably includes a pressure-sensitive adhesive layer alone.

In another aspect, the present invention provides a laminate which includes a member having a connecting terminal in an end area thereof; and the pressure-sensitive adhesive sheet, in which the connecting terminal is in contact with the non-adhesive region of the pressure-sensitive adhesive sheet.

### Advantageous Effects of Invention

The pressure-sensitive adhesive sheet according to the present invention has the configuration as mentioned above and thereby serves as a pressure-sensitive adhesive sheet which allows, when used to be attached to a member having a connecting terminal (e.g., FPC connector) in an end area thereof, the connecting terminal to be used easily without shape processing of the sheet.

### BRIEF DESCRIPTION OF DRAWINGS

FIG. 1 is a cross-sectional view illustrating an exemplary schematic structure of a laminate according to an embodiment of the present invention;

FIG. 2 is a perspective view illustrating an exemplary schematic structure of a pressure-sensitive adhesive sheet according to an embodiment of the present invention;

FIG. 3 is a cross-sectional view taken along line A-A′ in FIG. 2;

FIG. 4 is a perspective view illustrating an exemplary schematic structure of a transparent electrode substrate to be attached to the pressure-sensitive adhesive sheet according to the embodiment;

FIG. 5 is a cross-sectional view taken along line B-B′ in FIG. 4;

FIGS. 6a, 6b, 6c, and 6d are cross-sectional views illustrating an exemplary method for producing the pressure-sensitive adhesive sheet according to the embodiment;

FIG. 7 is a cross-sectional view illustrating an exemplary schematic structure of a customary laminate; and

FIG. 8 is a perspective view illustrating an exemplary schematic structure of a customary pressure-sensitive adhesive sheet.

### DESCRIPTION OF EMBODIMENTS

Some embodiments of the present invention will be illustrated in detail below with reference to FIGS. 1 to 6. As used herein the term “(from) A to B” indicating a range means that the range is “A or more and B or less”.

(I) Pressure-Sensitive Adhesive Sheet

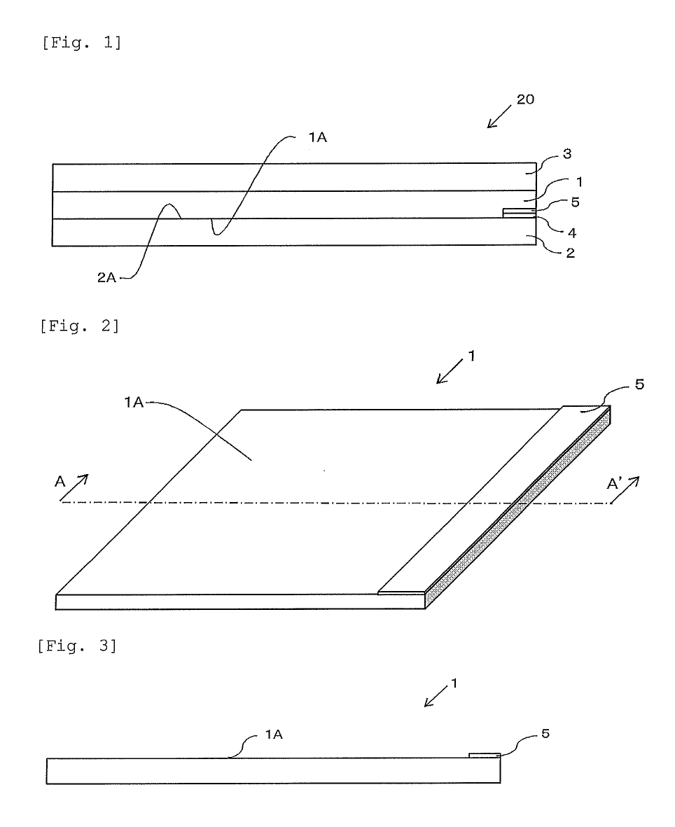

As illustrated in FIG. 1, a pressure-sensitive adhesive sheet 1 according to the embodiment is used as being attached to a member 2 having a connecting terminal 4 in an end area thereof. Specifically, the pressure-sensitive adhesive sheet 1 is attached to a region including the connecting terminal 4 in the member 2. With reference to FIGS. 2 and 3, the pressure-sensitive adhesive sheet 1 includes an adhesive face 1A. The adhesive face 1A is attached to the region including the connecting terminal 4. The adhesive face 1A has a non-adhesive region (nonadherent region) 5 as a region corresponding to the connecting terminal 4.

According to this configuration, the adhesive face 1A has the non-adhesive region 5 as a region corresponding to the connecting terminal 4. The pressure-sensitive adhesive sheet 1 therefore allows the connecting terminal 4 to be used easily even after the pressure-sensitive adhesive sheet 1 is attached to the member 2 having the connecting terminal 4 in the end area, because the connecting terminal 4 in the end area is in contact with the non-adhesive region 5. Accordingly, the connecting terminal 4 can be easily used without shape processing of the pressure-sensitive adhesive sheet 1.

Exemplary uses of the connecting terminal 4 after the attachment of the pressure-sensitive adhesive sheet according to the present invention include the use for obtaining external electric connection through a connector typically of an FPC. Specifically, in this use, another terminal is arranged between the connecting terminal 4 and the non-adhesive region 5 so as to establish an electric connection with an external device.

Pressure-Sensitive Adhesive

A pressure-sensitive adhesive constituting the pressure-sensitive adhesive sheet 1 is not limited and may be any of customarily known pressure-sensitive adhesives. They are typified by acrylic pressure-sensitive adhesives, silicone pressure-sensitive adhesives, polyoxyalkylene pressure-sensitive adhesives, urethane pressure-sensitive adhesives, rubber pressure-sensitive adhesives, polyester pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. Each of different pressure-sensitive adhesives may be used alone or in combination.

Preferred examples of the acrylic pressure-sensitive adhesives include an acrylic pressure-sensitive adhesive including, as a base polymer, an acrylic polymer having a monomer unit of an alkyl (meth)acrylate as a main skeleton. As used herein the term “(meth)acrylate” refers to “acrylate and/or methacrylate”.

The alkyl moiety of the alkyl (meth)acrylate constituting the main skeleton of the acrylic polymer preferably has 1 to about 18 carbon atoms on average. Examples of such alkyl (meth)acrylate include methyl (meth)acrylate, ethyl (meth)acrylate, n-butyl (meth)acrylate, 2-ethylhexyl (meth)acrylate, isooctyl (meth)acrylate, isononyl (meth)acrylate, and lauryl (meth)acrylate. Each of them may be used alone or in combination. Among them, alkyl (meth)acrylates whose alkyl moiety having 1 to 12 carbon atoms are preferred.

The silicone pressure-sensitive adhesives are not limited and are preferably any of generally widely used ones such as peroxide-crosslinking silicone pressure-sensitive adhesives (peroxide-curing silicone pressure-sensitive adhesives) and addition-reaction silicone pressure-sensitive adhesives. These peroxide-crosslinking silicone pressure-sensitive adhesives and addition-reaction silicone pressure-sensitive adhesives are also available as commercial products. Typically, examples of commercially available peroxide-crosslinking silicone pressure-sensitive adhesives include KR-3006A/BT supplied by Shin-Etsu Chemical Co., Ltd. and SH 4280 PSA supplied by Dow Corning Toray Co., Ltd. (formerly Dow Corning Toray Silicone Co., Ltd.), and examples of commercially available addition-reaction silicone pressure-sensitive adhesives include X-40-3501 supplied by Shin-Etsu Chemical Co., Ltd., BY 24-712 supplied by Dow Corning Toray Co., Ltd. (formerly Dow Corning Toray Silicone Co., Ltd.), and TSE32X supplied by Momentive Performance Materials Inc. (formerly GE Toshiba Silicone Co., Ltd.).

Exemplary polyoxyalkylene pressure-sensitive adhesives include the cured article disclosed in Japanese Unexamined Patent Application Publication (JP-A) No. 2008-266473, which is obtained from a composition including the following components A, B, and C:

A: Polyoxyalkylene polymer having at least one alkenyl group per one molecule;

B: Compound having two or more hydrosilyl groups on average per one molecule; and

C: Hydrosililation catalyst.

Non-Adhesive Region

The pressure-sensitive adhesive sheet 1 has the non-adhesive region 5 in the adhesive face 1A as a region corresponding to the connecting terminal 4, as illustrated in FIGS. 2 and 3. The non-adhesive region 5 is preferably arranged in an end area (end portion) of the adhesive face 1A, because the connecting terminal 4 is arranged in an end area of the member 2.

The non-adhesive region 5 is not limited, as long as being a region having substantially no adhesive property, and may be formed typically by providing a print layer on the adhesive face 1A; or by lying a film on the adhesive face 1A.

When the non-adhesive region is formed by providing a print layer on the adhesive face 1A, the print layer may be arranged directly on the adhesive face 1A or may be transferred from a separator or another base material having a releasable surface (releasable base material).

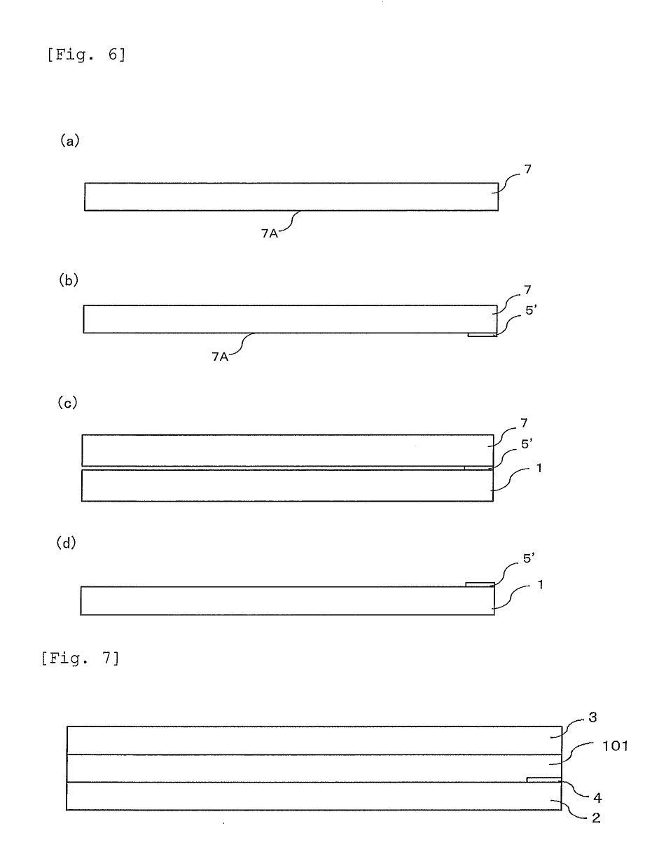

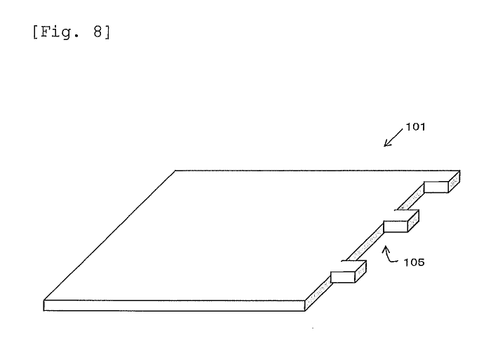

When the non-adhesive region is transferred from a releasable base material, the process may be specifically performed in the following manner. Initially, a releasable base material 7 having a releasable surface 7A is prepared (FIG. 6a). A print layer 5′ is formed on the releasable surface 7A (FIG. 6b). A pressure-sensitive adhesive sheet 1 is attached to the releasable surface 7A bearing the print layer 5′ (FIG. 6c). The pressure-sensitive adhesive sheet 1 is removed from the releasable base material 7 to thereby transfer the print layer 5′ from the releasable base material 7 to the pressure-sensitive adhesive sheet 1 and to form the print layer 5′ on the pressure-sensitive adhesive sheet 1 (FIG. 6d).

The way to form the print layer on the adhesive face 1A or on the base material is not limited and may be chosen suitably from among known techniques for forming print layers. Specifically, a print layer, when formed typically from an ink composition, may be formed by a technique of applying the ink composition to the predetermined surface and drying the applied composition according to necessity; or by a technique using a printing process such as gravure printing, flexographic printing, offset printing, relief printing, or screen process printing.

The ink composition for use herein is not limited, as long as capable of reducing the tackiness of the adhesive face 1A, and may be any of customarily known ink compositions.

Examples of the releasable base material include base materials each having a layer treated with a releasing agent; low-adhesive base materials each including a fluorocarbon polymer; and low-adhesive base materials each including a nonpolar polymer. Exemplary base materials each having a layer treated with a releasing agent include plastic films and papers undergone surface treatment with a releasing agent, which is typified by silicone releasing agents, long-chain alkyl releasing agents, fluorine-containing releasing agents, molybdenum sulfide, and shellac.

Examples of the fluorocarbon polymer constituting the low-adhesive base materials include polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-vinylidene fluoride copolymers. Examples of the nonpolar polymer constituting the base materials include olefinic resins such as polyethylenes and polypropylenes. The separator may be formed according to a known or customary procedure. The separator is not limited typically in thickness and other parameters.

The print layer has a thickness of preferably from 0.1 to 20 μm, more preferably from 0.3 to 10 μm, and furthermore preferably from 0.5 to 5 μm.

When the non-adhesive region is formed by arranging a film on the adhesive face 1A, the film for use herein is not limited, as long as whose surface does not have tackiness, and is typified by plastic films including films of polyolefins such as polyethylenes, polypropylenes, and ethylene-propylene copolymers, films of polyesters such as polyethylene terephthalate)s, and films of poly(vinyl chloride)s; papers such as kraft paper and Japanese paper; fabrics such as cotton fabrics and staple fiber fabrics (e.g., spun rayon fabrics); nonwoven fabrics such as polyester nonwoven fabrics and vinylon nonwoven fabrics; and metallic foils.

The plastic films may either non-oriented films or oriented (uniaxially oriented or biaxially oriented) films. A side of a base material on which the pressure-sensitive adhesive layer is provided may have undergone primer coating, corona discharge treatment or another surface treatment.

The film used for the formation of the non-adhesive region has a thickness of preferably from 0.1 to 75 μm, more preferably from 0.5 to 25 μm, and furthermore preferably from 1 to 10 μm.

Pressure-Sensitive Adhesive Sheet

The adhesive face 1A in the pressure-sensitive adhesive sheet 1 may have a shape not critical and suitably changeable according to an intended usage pattern. In a preferred embodiment, the adhesive face 1A has a size approximately the same with the size of a surface 2A of the member 2 including the connecting terminal 4, as illustrated in FIG. 1. This allows the pressure-sensitive adhesive sheet 1 to be easily attached to the member 2.

The pressure-sensitive adhesive sheet 1 may be a pressure-sensitive adhesive sheet including a pressure-sensitive adhesive layer alone (substrate-less double-coated pressure-sensitive adhesive sheet) or a pressure-sensitive adhesive sheet having a substrate (carrier), but is preferably a pressure-sensitive adhesive sheet including a pressure-sensitive adhesive layer alone.

The substrate is not limited and may be any of customarily known plastic films.

Though not critical, the substrate has a thickness of typically preferably from 1 to 1000 μm. The substrate may have a single-layer structure or a multilayer structure. The surface of the substrate may have been subjected to a known or customary surface treatment, which is typified by physical treatments such as corona discharge treatment and plasma treatment; and chemical treatments such as primer coating.

Though the preparation method thereof is not limited, the pressure-sensitive adhesive sheet 1 may be formed typically by coating a substrate or release liner with a pressure-sensitive adhesive composition for the formation of the pressure-sensitive adhesive, and drying and/or curing the coated composition according to necessity.

The application (coating) of the pressure-sensitive adhesive composition may employ a known coating technique by using a customary coater such as rotogravure roll coater, reverse roll coater, kiss-contact roll coater, dip roll coater, bar coater, knife coater, spray coater, comma coater, or direct coater.

A separator (release liner) may be arranged on the adhesive face(s) of the pressure-sensitive adhesive sheet 1 before use. When the pressure-sensitive adhesive sheet according to the present invention is a double-coated pressure-sensitive adhesive sheet, two adhesive faces may be protected by two separators respectively. Alternatively, the pressure-sensitive adhesive sheet may be wound as a roll, in which the two adhesive faces are protected by one separator having release surfaces as both sides thereof. The separator is used as a protecting member for the pressure-sensitive adhesive layer and is removed when the pressure-sensitive adhesive sheet is attached to an adherend. When the pressure-sensitive adhesive sheet according to the present invention is a substrate-less pressure-sensitive adhesive sheet, the separator also serves as a support for the pressure-sensitive adhesive layer.

It is not always necessary to provide a separator on the pressure-sensitive adhesive sheet 1. The separator may be, for example, a customary release paper not limited and is typified by the aforementioned releasable base materials.

Though not critical, the pressure-sensitive adhesive sheet 1 has a thickness of typically preferably from 0.5 to 500 μm, more preferably from 2 to 250 μm, and furthermore preferably from 2 to 100 μm.

Member Having Connecting Terminal in End Area Thereof

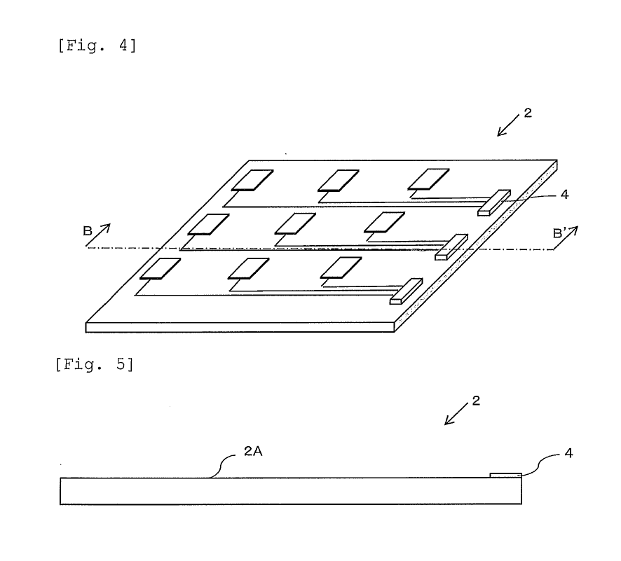

The member for use herein is not limited and is exemplified by electrode substrates including transparent electrode substrates, such as indium-tin-oxide (ITO) electrode substrates, as illustrated in FIGS. 4 and 5; circuit boards such as flexible printed circuit (FPC) boards; and liquid crystal display devices.

The connecting terminal 4 of the member 2 is not limited, as long as being a terminal capable of establishing an electric connection with an external member, and may be any of customarily known connecting terminals.

In an FPC board, for example, a pressure-sensitive adhesive sheet is used typically in a process of bonding the FPC board to a reinforcing plate such as an aluminum plate, a stainless steel plate, or a polyimide plate. When the member 2 is an FPC board having connecting terminals 4 in an end area thereof, the pressure-sensitive adhesive sheet 1 not only allows easy use of the connecting terminals but also suppresses the occurrence of problems or troubles typically in solder reflow process performed after the attachment of the FPC board to the reinforcing plate.

Specifically, if a pressure-sensitive adhesive sheet having a customary structure in which the pressure-sensitive adhesive sheet is removed in portions corresponding to the connecting terminals as illustrated in FIG. 8 is used for affixing an FPC board and a reinforcing plate with each other, bumps (steps) corresponding to the thickness of the pressure-sensitive adhesive sheet are formed in the end area to cause deformation of the FPC board and/or to cause contamination typically of bubbles upon affixation of the FPC board and the reinforcing plate with each other. These may cause problems typically in the solder reflow process.

(II) Laminate

With reference to FIG. 1, a laminate 20 according to an embodiment of the present invention includes a member 2 having one or more connecting terminals 4 in an end area thereof; and the pressure-sensitive adhesive sheet 1 according to the present invention, in which the connecting terminal(s) 4 is in contact with the non-adhesive region 5 of the pressure-sensitive adhesive sheet 1.

In the laminate according to this embodiment, an optical member 3 is arranged on an adhesive face of the pressure-sensitive adhesive sheet 1 opposite to the adhesive face 1A facing the member 2 having the connecting terminal(s) in an end area thereof. However, the present invention is not limited to this configuration. Another member such as a reinforcing plate may be arranged instead of the optical member 3; or no member may be arranged.

As used herein the term “optical member” refers to a member having any of optical properties such as polarizability, photorefractivity, light scattering, light reflectivity, optical transparency, optical absorptivity, optical diffractive ability, optical rotatory power, and visibility. The optical member is not limited, as long as being a member having any of optical properties, and examples thereof include members constituting, or being used in, devices (optical devices) such as display devices (image display devices) and input devices. Specifically, exemplary optical members include polarizing plates, wave plates, retardation films (phase difference films), compensation films, brightness enhancing films, light-guiding panels, reflective films, antireflective films, transparent electroconductive films (e.g., indium-tin-oxide (ITO) films), films with a graphical design function, decorative films, surface-protective plates, prisms, lenses, color filters, and transparent substrates; and laminates of these members. These may be generically referred to as “functional films”. As used herein, the terms “plate (or panel)” and “film” refer to and include articles in the form typically of plates, films, and sheets, respectively. Typically, the term “polarizing plates” also includes “polarizing films” and “polarizing sheets.”

In the configuration illustrated in this embodiment as in FIG. 2, the entire one side of the adhesive face 1A serves as the non-adhesive region 5; but the present invention is not limited to this configuration. Typically, for higher tackiness, only a region or regions corresponding to the connecting terminal(s) 4 may be a non-adhesive region(s) 5 in the pressure-sensitive adhesive sheet.

In the configuration exemplified in this embodiment, the non-adhesive region 5 is provided on only one surface of the pressure-sensitive adhesive sheet 1; but the present invention is not limited to this configuration. Typically, when two members 2 each having a connecting terminal 4 in an end area thereof are applied to both surfaces of the pressure-sensitive adhesive sheet, the non-adhesive region 5 may be formed in regions corresponding to the respective connecting terminals 4. Alternatively, the non-adhesive region 5 may be formed in the entire peripheral end area (namely, so as to surround the end area).

It is to be understood that the present invention is not limited to the above-described specific embodiments; that various modifications and alternations may be made without departing from the scope and spirit of the present invention as determined by the appended claims; and that all embodiments as obtained by suitable combinations of technical means disclosed in different embodiments should be considered to be within the scope of the present invention.

### INDUSTRIAL APPLICABILITY

The pressure-sensitive adhesive sheet according to the present invention has, in an adhesive face, a non-adhesive region as a region corresponding to a connecting terminal and is thereby advantageously usable as a pressure-sensitive adhesive sheet for various members each having such a connecting terminal in an end area thereof.

### REFERENCE SIGNS LIST

1 pressure-sensitive adhesive sheet
1A adhesive face
2 transparent electrode substrate (member having a connecting terminal in an end area thereof)
3 optical member
4 connector (connecting terminal)
5 non-adhesive region
5′ print layer (non-adhesive region)
7 releasable base material
20 laminate

1. A pressure-sensitive adhesive sheet to be attached to a region of a member having a connecting terminal in an end area thereof, the region including the connecting terminal,
the pressure-sensitive adhesive sheet comprising an adhesive face to be attached to the region including the connecting terminal, and
the adhesive face having a non-adhesive region as a region corresponding to the connecting terminal.

2. The pressure-sensitive adhesive sheet according to claim 1, wherein the adhesive face has a size approximately the same with that of a surface of the member, the surface including the region including the connecting terminal.

3. The pressure-sensitive adhesive sheet according to claim 1, wherein the non-adhesive region is a region of a print layer present on the adhesive face.

4. The pressure-sensitive adhesive sheet according to claim 1, which is a double-coated pressure-sensitive adhesive sheet.

5. The pressure-sensitive adhesive sheet according to claim 1, comprising a pressure-sensitive adhesive layer alone.

6. A laminate comprising:
a member having a connecting terminal in an end area thereof; and
the pressure-sensitive adhesive sheet of claim 1,
the connecting terminal being in contact with the non-adhesive region of the pressure-sensitive adhesive sheet.

7. The pressure-sensitive adhesive sheet according to claim 2, wherein the non-adhesive region is a region of a print layer present on the adhesive face.

8. The pressure-sensitive adhesive sheet according to claim 2, which is a double-coated pressure-sensitive adhesive sheet.

9. The pressure-sensitive adhesive sheet according to claim 3, which is a double-coated pressure-sensitive adhesive sheet.

10. The pressure-sensitive adhesive sheet according to claim 7, which is a double-coated pressure-sensitive adhesive sheet.

11. The pressure-sensitive adhesive sheet according to claim 2, comprising a pressure-sensitive adhesive layer alone.

12. The pressure-sensitive adhesive sheet according to claim 3, comprising a pressure-sensitive adhesive layer alone.

13. The pressure-sensitive adhesive sheet according to claim 4, comprising a pressure-sensitive adhesive layer alone.

14. The pressure-sensitive adhesive sheet according to claim 7, comprising a pressure-sensitive adhesive layer alone.

15. The pressure-sensitive adhesive sheet according to claim 8, comprising a pressure-sensitive adhesive layer alone.

16. The pressure-sensitive adhesive sheet according to claim 9, comprising a pressure-sensitive adhesive layer alone.

17. The pressure-sensitive adhesive sheet according to claim 10, comprising a pressure-sensitive adhesive layer alone.

18. A laminate comprising:
a member having a connecting terminal in an end area thereof; and
the pressure-sensitive adhesive sheet of claim 2,
the connecting terminal being in contact with the non-adhesive region of the pressure-sensitive adhesive sheet.

19. A laminate comprising:
a member having a connecting terminal in an end area thereof; and
the pressure-sensitive adhesive sheet of claim 3,
the connecting terminal being in contact with the non-adhesive region of the pressure-sensitive adhesive sheet.

20. A laminate comprising:
a member having a connecting terminal in an end area thereof; and
the pressure-sensitive adhesive sheet of claim 4,
the connecting terminal being in contact with the non-adhesive region of the pressure-sensitive adhesive sheet.
